(19) United States
(12) Patent Application Publication
(10) Pub. No.: US 2003/0100232 A1
(43) Pub. Date: May 29, 2003

(54) Headliner and method of manufacturing the same

(76) Inventors: Larry F Kocher, Canton, MI (US); Janusz P Gorowicz, Pinckney, MI (US); Normand R Marceau, Linden, MI (US)

Correspondence Address: Robin W Asher, Clark Hill, Suite 3500, 500 Woodward Avenue, Detroit, MI, 48226-3435, US

(21) Appl. No.: 10/332,293

(22) PCT Filed: Jul. 6, 2001
(86) PCT No.: PCT/CA01/00995

(51) Int. Cl. B32B 5/12; B32B 27/04; D04H 1/00; B26F 1/00; B29C 70/02; B29C 70/46

(52) U.S. Cl. 442/32; 442/50; 442/38; 442/58; 264/257; 264/320; 264/154

(57) ABSTRACT

A headliner (10) for use with a motor vehicle including a combination of a chopped fiber roving (22) bonded between a non-woven film layer and a urethane core (14) to eliminate warpage in the headliner (10) after the molding and forming process is complete. The combination of stiffness and mechanical bond provides this effect. The combination may also include a polypropylene non-woven material (18) combined with a polyethylene film (20) to form a laminate top (12) and bottom layer (16). The chopped fiber roving (22) is randomly disposed between the laminate (21) and a urethane matrix (44) used to form a core (14) of the headliner (10) to provide the shape stability to the headliner (1).

### BACKGROUND OF THE INVENTION

1. Field of the Invention

The present invention relates to a headliner for use with a motor vehicle and, more particularly, to a headliner formed of multiple layers to provide shape stability and a method of manufacturing the same.

2. Description of the Related Art

Headliners are used with motor vehicles to provide a pleasing finish to the interior of a vehicle compartment. Headliners also provide for sound absorption and insulation and accordingly increase the quality of environment in the vehicle compartment.

Headliners typically include a number of different layers of material. Typically, they are formed of a foam or urethane core sprayed between two reinforcing layers. The layers of material are assembled and then molded into the desired shape, normally the shape of the vehicle ceiling. Current urethane headliners tend to warp shortly after demolding and often retain the distorted shape permanently.

Therefore, it is desirable to provide a multi-layer headliner, and method of manufacturing same, such that the headliner will retain its molded shaped and not warp after being removed from the mold.

### SUMMARY OF THE INVENTION

The present invention provides a headliner and method of making the same that overcomes the problem of permanent warpage normally occurring shortly after demold. According to one aspect of the invention a headliner is formed of top and bottom layers having a urethane matrix sprayed between the layers to form the core. The headliner includes a separate scrim layer, a film layer, and a chopped fiber material randomly distributed between the film layer and the urethane core. In some instances, a binder material may be used to increase adherence of the chopped fiber material to the film layer. The film layer is perforated to allow for degassing of the urethane matrix.

According to another aspect of the invention a method is provided for forming a headliner for an automotive vehicle. The method includes the steps of providing a top layer and bottom layer of laminated non-woven polypropylene scrim and polyethylene film, providing a layer of fiberglass mat between the top and bottom layers, dispensing a urethane matrix onto the layer of fiberglass mat between the top and bottom layers, and randomly dispersing a chopped fiber material between at least one of the top and bottom layers and the urethane matrix to provide internal structural rigidity to the headliner.

Accordingly, the combination of the chopped fiber material and a nonwoven film provide a synergistic effect that eliminates headliner warpage. The combination of stiffness and mechanical bond between the film layer and chopped fiber material randomly distributed between the film layer and urethane core provides this effect.

### BRIEF DESCRIPTION OF THE DRAWINGS

Other features and advantages of the present invention will be readily appreciated as the same becomes better understood after reading the subsequent description when considered in connection with the accompanying drawings wherein:

FIG. 1 is a top view of an automotive headliner according to the present invention;

FIG. 2 is an enlarged partial cross-sectional view of the headliner of FIG. 1 taken along line 2-2 of FIG. 1;

FIG. 3 is a schematic side view of an apparatus using a method of forming the headliner of the present invention with the press shown in the open position; and

FIG. 4 is a schematic side view of an alternative embodiment of an apparatus using a method of forming the headliner of the present invention with the press shown in the open position.

### DETAILED DESCRIPTION OF THE PREFERRED EMBODIMENTS

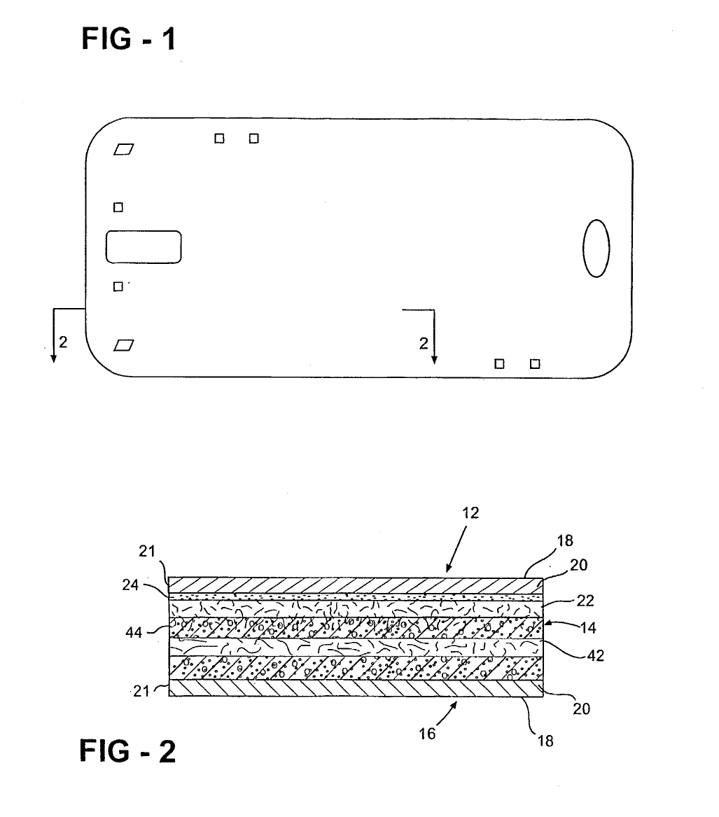

Referring to FIG. 1, there is illustrated a headliner 10 of the present invention. The headliner 10 conforms and fits to the ceiling of the passenger compartment of a motor vehicle. The headliner 10 is formed as a laminate including a top layer 12, a urethane core 14 and a bottom layer 16.

As shown in FIG. 2, each of the top and bottom layers 12, 16 include a nonwoven polypropylene scrim 18 and a polyethylene film 20 combined to form a laminate 21. The non-woven polypropylene scrim 18 is preferably supplied by weight, specifically, 0.1 to 2.0 ounces per square yard, while the polyethylene film 20 is preferably 0.0005 to 0.003 inches thick.

The scrim 18 and film 20 are laminated by a combination of heat and pressure through nip rolls. Nip rolls are a pair of opposed rollers having a small gap therebetween. The rollers are heated to a temperature of about 160 degrees Fahrenheit and the scrim 18 and film 20 are run through the heated rollers to create a bond and laminate the scrim 18 and film 20. The laminate 21 is then perforated. Perforation of the laminate 21 allows air and gas to permeate through the laminate 21 during the step of forming the core 14.

The core 14 is formed from a layer of a fiberglass mat 42 embedded in a urethane matrix of foam 44.

A chopped fiberglass roving 22 is randomly distributed between the film 20 of the top layer 12 and the core 14. In one embodiment of the invention, the chopped fiberglass roving 22 is randomly distributed on the film 20. When the chopped fiberglass roving 22 is distributed on the film 20 prior to forming the substrate; i.e. when the laminate 21 includes the chopped fiberglass roving 22, a binder material 24 is also distributed on the film 20 and operates to adhere the chopped fiberglass roving 22 to the film 20. The binder material 24 may be distributed on the film 20 along with the chopped fiberglass roving 22. The binder material 24 is a polyester powder adhesive that can be purchased from Bostick of Middleton, Mass. When used, the binder material 24 is applied by weight, specifically, 1 to 20 percent, by means of a shaker box that distributes at random a specific amount of the adhesive. The weight of the chopped fiberglass roving 22 determines the amount of binder 24 required; e.g., 40 grams per square meter requires 5 grams of powder adhesive or approximately 12 percent by weight. The fiberglass roving 22 is formed of fiberglass strands having a diameter of 0.03 inches chopped into two-inch lengths. As set forth above, the chopped fiberglass is randomly distributed on either the polyethylene film 20 or the urethane core 14 at a density of 5 to 150 grams per square meter. It should be appreciate that the fiberglass roving 22 may alternatively be randomly distributed between the polyethylene film 20 of the bottom layer 16 and the core 14 or between both the top and bottom layers 12, 16 and the core 14.

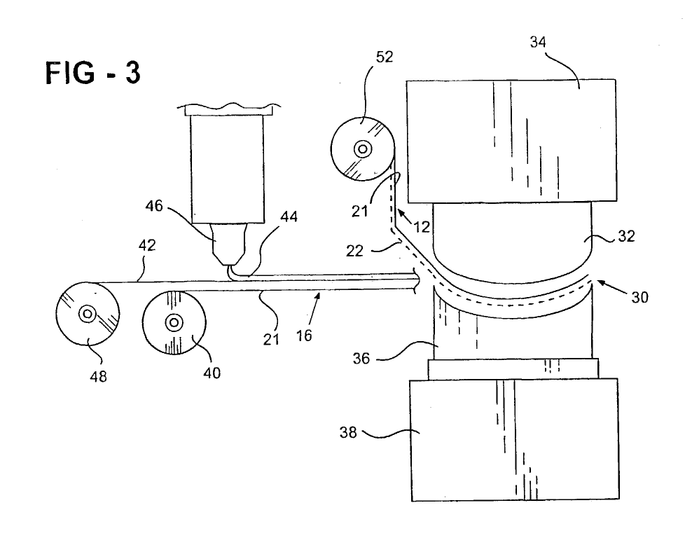

Turning now to FIG. 3, there is shown an apparatus for use with the method for forming the headliner panel 10. The apparatus includes a forming tool or die 30 shown with an upper platen 32 attached to a press head 34 and a lower platen 36 attached to a press bed 38. The laminate 21 forms both the top 12 and bottom 16 layers of the headliner 10 and is supplied as a rolled good from supply rollers 40, 41. The fiberglass mat 42 is supplied as a rolled good from supply roller 48. During the manufacturing process, as the glass mat 42 is rolled or pulled into the forming tool 30, the urethane matrix 44 is sprayed onto the glass mat 42 by a urethane spray head 46. Next, the chopped fiberglass roving 22 is distributed from a hopper 50 onto the urethane matrix 44, after which the entire assembly including the top layer 12, chopped fiberglass roving 22, urethane matrix 44, glass mat 42, and bottom layer 16 are placed in the forming tool 30 which operates, through a molding cycle, to form the headliner 10. In this method or process, no binder 24 is used. If required, additional glass or other fibers can be added as rolled goods prior to spraying the urethane matrix 44. Also, additional chopped fiber materials such as jute, sisal, or hemp may be used in place of the chopped fiberglass roving 22.

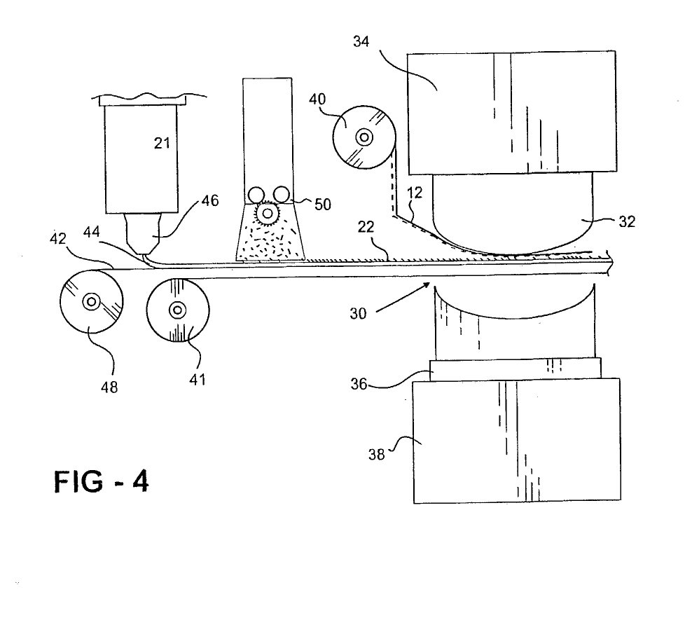

Turning now to FIG. 4, an alternative embodiment of an apparatus and method for manufacturing a headliner 10 is shown. Again, a forming tool or die 30 receives the headliner 10 components from a plurality of supply rollers. The lower or bottom layer 16 is the laminate 21 supplied as a rolled good drawn from supply roller 40. A fiberglass mat 42 is also supplied from a supply roll 48. Once again, prior to the molding process, a urethane matrix 44 is deposited on the fiberglass mat 42 by a urethane spray head 46. The top layer 12 includes the laminate 21 with the chopped fiberglass roving 22 already secured thereto by a binder material 24. The top layer 12 is supplied as a rolled good from a supply roller 52.

Accordingly, the chopped fiberglass roving 22 gives internal structure to the headliner 10 as the urethane matrix 44 adheres to the chopped fiberglass roving 22 to prevent the headliner 10 from warping after shaping and molding in the forming tool 30. It should be understood that the film 20, while perforated to allow the air and gas to escape therethrough, provides a barrier that prevents the urethane matrix 44 from leaking through to the outer surface of the headliner 10. Finally, the scrim 18 provides an anti-squeak and smooth surface quality to the outer surface of the headliner 10.

Pursuant to the present invention, the chopped fiber material combines with the polypropylene non-woven material and polyethylene film to prevent warpage in headliners and similar products. As disclosed herein, various chopped fiber materials may be used. The invention teaches inline random distribution of the chopped fiber material during introduction directly onto the urethane matrix. Alternatively, the chopped fiber material is randomly distributed on and attached to the polypropylene non-woven material and polyethylene film laminate by a binder material prior to layering with the urethane matrix.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A headliner for use in an automotive vehicle comprising:
a top layer and a bottom layer, each of said top and botton layers including a laminated scrim layer and film layer;
a urethane matrix disposed between said top layer and said bottom layer and forming a urethane core; and
a chopped fiber material randomly distributed between at least one of said top layer and said bottom layer and said urethane matrix.

2. A headliner as set forth in claim 1 wherein said urethane matrix includes a layer of fiberglass mat and a layer of urethane foam.

3. A headliner as set forth in claim 2 wherein said top layer includes a non-woven polypropylene scrim.

4. A headliner as set forth in claim 3 wherein said top layer includes a polyethylene film bonded to said scrim to form a top laminate.

5. A headliner as set forth in claim 4 wherein said bottom layer includes a non-woven polypropylene scrim.

6. A headliner as set forth in claim5 wherein said bottom layer includes a polyethylene film bonded to said scrim to form a bottom laminate.

7. A headliner as set forth in claim 6 wherein said urethane matrix includes a fiberglass mat embedded in a layer of urethane foam between said top and botton layers.

8. A headliner as set forth in claim 7 wherein said chopped fiber material includes strands of chopped fiberglass roving randomly distributed between one of said top and bottom layers and said urethane matrix.

9. A headliner as set forth in claim 8 wherein said chopped fiber material includes jute.

10. A headliner as set forth in claim 8 wherein said chopped fiber material includes sisal.

11. A headliner as set forth in claim 8 wherein said chopped fiber material includes hemp.

12. A method of forming a headliner for an automotive vehicle comprising the steps of:
providing a top layer and bottom layer of laminated non-woven polypropylene scrim and polyethylene film;
providing a layer of fiberglass mat between the top and bottom layers;
dispensing a urethane matrix onto the layer of fiberglass mat between the top and bottom layers; and
randomly dispersing a chopped fiber material between at least one of the top and bottom layers and the urethane matrix to provide internal structural rigidity to the headliner.

13. A method as set forth in claim 12 further including applying a binder material between the chopped fiber material and one of the top and bottom layer to adhere the fiber material to the layer.

14. A method as set forth in claim 13 further including placing the top and bottom layers with the urethane matrix, fiberglass mat and chopped fiber therebetween onto a lower platen of a forming tool, closing an upper platen against the lower platen and forming the layers into a predetermined contoured headliner.

15. A method as set forth in claim 14 further including perforating the polyethylene film to allow air and gas to escape therethrough.

16. A method as set forth in claim 12 including spraying the urethane matrix onto the layer of fiberglass mat positioned between the top and bottom layers and then randomly dispensing the chopped fiber material onto the urethane matrix between the urethane matrix and at least one of the top and bottom layers.
